(19) United States
(12) Patent Application Publication
(10) Pub. No.: US 2019/0050005 A1
(43) Pub. Date: Feb. 14, 2019

(54) FORCE OR TORQUE CONTROL AND ESTIMATION USING HIGH TRANSPARENCY ELECTROMECHANICAL MANIPULATOR WITH ONLY JOINT ENCODERS

(71) Applicant: THE TRUSTEES OF THE UNIVERSITY OF PENNSYLVANIA, Philadelphia, PA (US)

(72) Inventors: Gavin KENNEALLY, Philadelphia, PA (US); Avik DE, Philadelphia, PA (US)

(73) Assignee: The Trustees of the University of Pennsylvania, Philadelphia, PA (US)

(21) Appl. No.: 16/075,906

(22) PCT Filed: Feb. 2, 2017
(86) PCT No.: PCT/US2017/016151

§ 371 Date: Aug. 6, 2018

Related U.S. Application Data
(60) Provisional application No. 62/292,128, filed on Feb. 5, 2016.

(51) Int. Cl. G05D 17/02; G05B 17/02; B25J 9/00; G05D 15/01

(52) U.S. Cl. CPC G05D 17/02; G05B 17/02; G05B 2219/34013; G05D 15/01; G05B 2219/39001; B25J 9/0009

(57) ABSTRACT

A method of controlling a motor may include receiving command data indicating only a desired torque and/or force for the motor and including no torque and/or force or current feedback data from the motor. Based on the command data and at least one motor characteristic and no separate torque and/or force or current feedback data, a voltage signal corresponding to a desired motor current to produce the desired torque and/or force may be generated. A control signal configured to provide the motor with the desired motor current may be generated using only the voltage signal as an input. The motor may be controlled by inputting the control signal to the motor, and the inputting may cause the motor to output substantially the desired torque and/or force.

### CROSS-REFERENCE TO RELATED APPLICATION

This application claims the benefit of priority from U.S. Provisional Application No. 62/292,128, filed Feb. 5, 2016, the entirety of which is incorporated by reference herein.

### GOVERNMENT LICENSE RIGHTS

This invention was made with government support under grant no. W911NF-10-2-0016 awarded by the U.S. Army. The government has certain rights in the invention.

### BRIEF DESCRIPTION OF THE DRAWINGS

FIG. 1 is a block diagram of a robotic manipulator according to an embodiment of the invention.

FIG. 2 is a motor according to an embodiment of the invention.

FIG. 3 is a block diagram of a control system according to an embodiment of the invention.

FIG. 4 is a motor control process according to an embodiment of the invention.

FIG. 5 is a block diagram of a control system configured to perform sinusoidal commutation according to an embodiment of the invention.

FIG. 6 is a comparison of manipulators according to an embodiment of the invention.

FIG. 7 is a comparison of serial and parallel linkages according to an embodiment of the invention.

FIG. 8 is a block diagram of an electrical system according to an embodiment of the invention.

FIG. 9 is a block diagram of a motor and a microcontroller according to an embodiment of the invention.

### DETAILED DESCRIPTION OF SEVERAL EMBODIMENTS

Systems and methods described herein may perform force and/or torque control and/or estimation for a rotary electric motor using only a high resolution position sensor. These systems and methods may be used for power-autonomous mobile robots, for example. Accordingly, such robots may require a single position transducer per joint to give the rotor's state (position/velocity), and may not require any other sensors for this task (including but not limited to high-side/low-side current sensors, per-phase current sensors, spring deflection sensors, or end-effector force/torque sensors).

The methodology described herein may depend on minimizing the motor controller, motor, transmission, and manipulator dynamics through purposeful design, taking advantage of the specifics of low-end-effector-speed servo control regime as may be found in robotic manipulators. These approximations may allow high-accuracy forward models of the behavior of each subsystem to be defined. Moreover, the resulting composition may provide an analytical mapping between forces produced at the end-effector and command signals.

The system may be rigid (no mechanical springs etc.) so the compliance may be dictated completely by a control law in software if necessary, using a joint encoder already included for commutation. Accordingly, the system may be programmable on the fly and may allow arbitrary stiffness and damping (e.g., up to actuator torque limits and control bandwidth). A direct-drive or low gear ratio motor may be used to minimize unwanted actuator dynamics (e.g., reflected inertia, frictions, backlash, etc.) so that the commanded signals dominate the interaction forces.

The systems and methods described herein may provide precise feed-forward control of motor output force (or torque) based only on an input defining the desired output force (or torque). In some embodiments, the input may be in terms of desired force, using force units, and in other embodiments, the input may be in terms of desired torque, using torque units. In other embodiments, the input may be in terms of multiple desired forces and torques for a system comprising multiple motors. For example, precision may be great enough that the real output force (or torque) matches the desired output force(or torque) within 5-20% error for stationary applications and/or within 10-30% error throughout a motor's velocity/acceleration range. This may be accomplished without any force or current feedback. Some embodiments may use position feedback only to provide certain additional features.

### Motor System

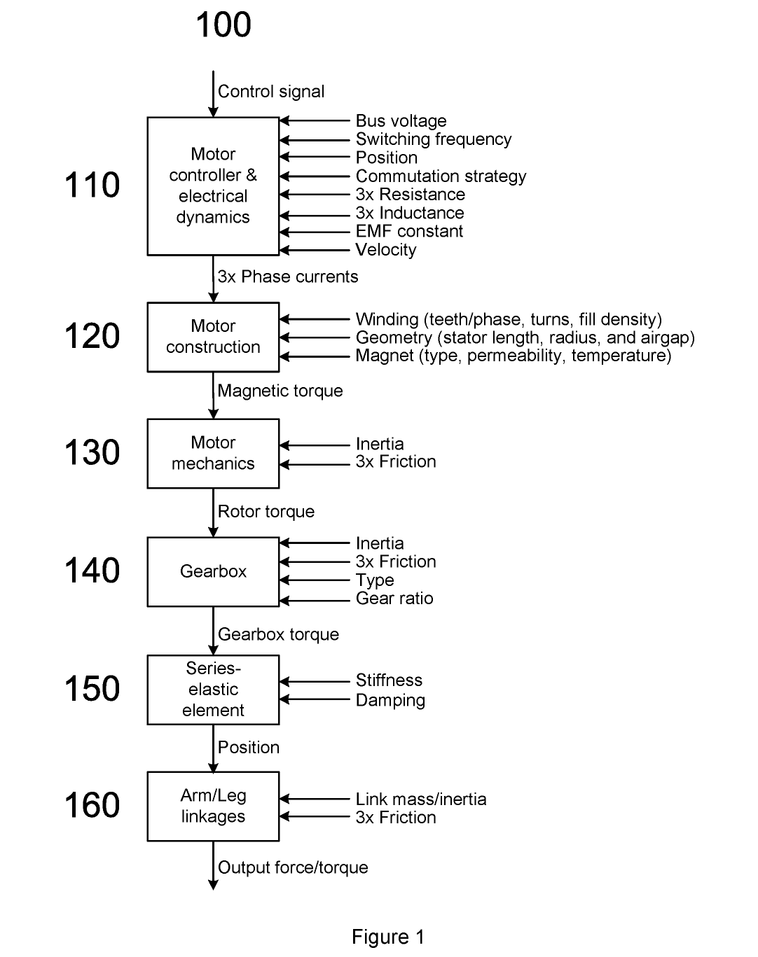

FIG. 1 is a block diagram of a robotic manipulator 100 according to an embodiment of the invention. The block diagram presents a general structure for a robotic manipulator 100 (arm, leg, etc.) driven by a 3-phase PMSM (permanent magnet synchronous motor) or BLDC (brush less DC) motor. The system may include a motor controller and electrical dynamics 110, motor construction 120, motor mechanics 130, gearbox 140, series-elastic element 150, and arm/leg linkages 160. As shown, motor controller and electrical dynamics 110 receives control signals and sensor data and outputs 3× phase currents. Motor construction 120 may receive phase currents and, as a function of winding, geometry, and magnet characteristics, generate a magnetic torque. Motor mechanics 130 may convert the magnetic torque to rotor torque. Gearbox 140 alters the rotor torque through a mechanical advantage which may be accomplished by gears, harmonic drive, cycloid drive, belts, chains, or other means of reduction. Series-elastic element 150 may use rotor torque to position arm/leg linkages 160, which may deliver an output force or torque to an external element (e.g., applying a force to an object or the ground, etc.).

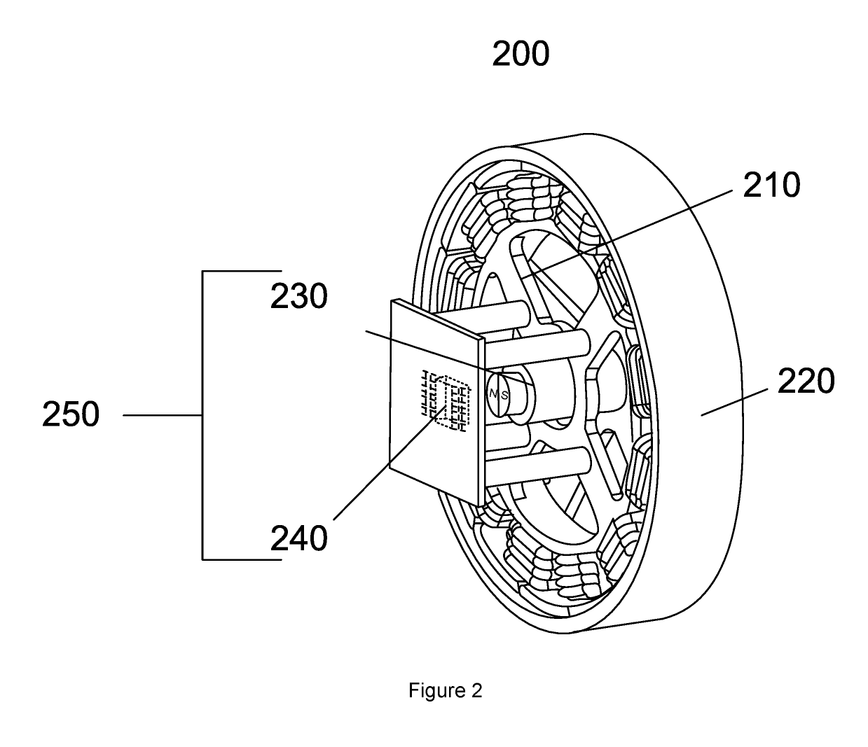

FIG. 2 is a motor 200 according to an embodiment of the invention. The example motor 200 is a direct-drive brushless DC motor with magnetic position sensor 250. Motor 200 includes a stator 210 connected to a frame that contains the motor's electromagnets. Motor 200 includes a rotor 220 connected to a load that experiences the aforementioned torque, τ. A diametrically polarized magnet 230 may be rigidly attached to the inside of rotor 220. The position, θ, of magnet 230 may be transduced by a magnetic encoder integrated circuit (IC) 240 attached to the frame and stator 210. Magnet 230 and IC 240 may together form a sensor 250 configured to detect θ. Many such actuators (motor 200 and sensor 250) may be combined in arbitrary linkages to predict multi-dimensional forces at the end-effector.

### Motor Control

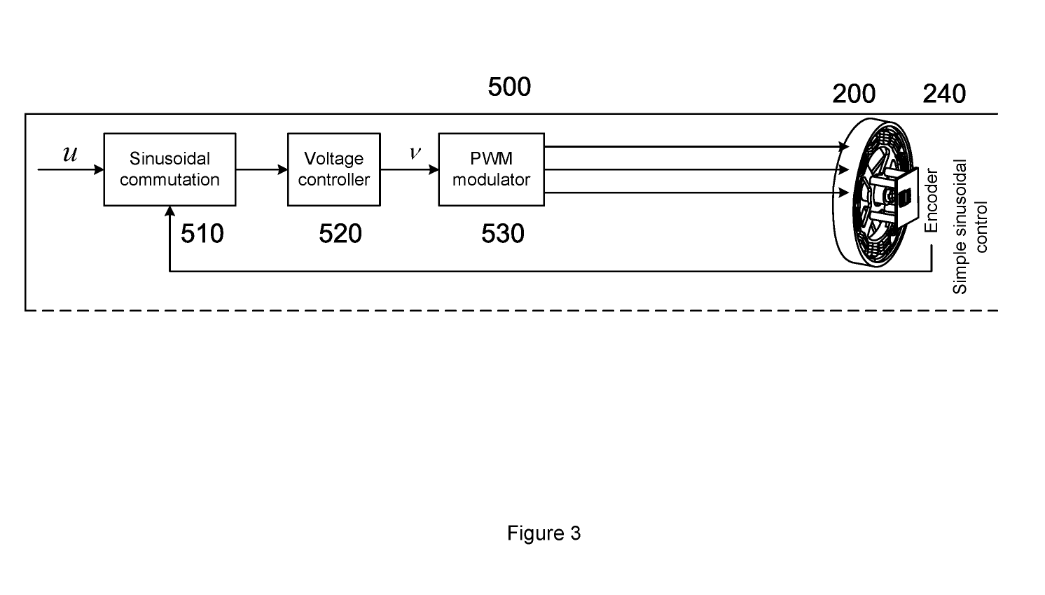

FIG. 3 is a block diagram of a control system 500 according to an embodiment of the invention. Control system 500 may include sinusoidal commutation module 510, voltage controller module 520, and/or pulse width modulation (PWM) module 530. Control system 500 may be implemented by microcontroller 300, a combination of microcontroller 300 and drive electronics 410, or discrete components (e.g., dedicated sinusoidal commutation circuitry, voltage controller circuitry, and/or PWM circuitry), or a combination thereof, for example.

Control system 500 may control motor 200. As detailed below, to control motor 200, control system 500 may start with an input desired force (or torque). Control system 500 may translate the input desired force (or torque) to a control signal that controls motor 200 to generate an output force (or torque) that is substantially the desired force (or torque) (e.g., within 5-20% error for stationary applications and/or within 10-30% error throughout a motor's velocity/acceleration range). The desired force (or torque) is achieved as the output force (or torque) by selecting a control value (i.e., the input desired force) without feedback. Motor systems may accordingly operate without force, torque, or current feedback sensors.

Table 1 provides a listing of symbols and their meanings that are used herein to describe the processing performed by control system 500.

TABLE 1

| Symbol | Meaning (SI unit) |
|---|---|
| u | Control input |
| v | Voltage (V) |
| i | Current (A) |
| kₑ | Motor EMF constant (V/rad/s) |
| kₜ | Motor torque constant (Nm/A)—this is numerically equal to kₑ |
| qᵣ, \dot{q}ᵣ, \ddot{q}ᵣ | Rotor angular position (rad), velocity (rad/s), acceleration (rad/s²) |
| R | Motor resistance (Ω) |
| L | Motor inductance (H) |
| k_{F}, k_{P}, k_{I} | Motor controller current control parameters |
| t_{pwm} | PWM switching time (s) |
| tₘₒₜ | Motor electrical time constant, ${t}_{mot} = \frac{L}{R} ( S )$ |
| e | Current controller tracking error $e \text{:=} \frac{u}{{k}_{t}} - i ( A )$ |
| τₘ, τᵣ, τ_{g} | Magnetic, rotor, and gearbox torque (Nm) |
| m, n, r | Stator teeth per phase, length (m), and radius (m) |
| n | Wire turns |
| ρ, c, B | Magnet permeability (H/m), type, field (T) |
| T | Temperature (°K) |
| Jᵣ, J_{g} | Rotor and gearbox moment of inertia (kg m²) |
| bᵣ, b_{g} | Rotor and gearbox damping (Nm/rad/s) |
| μᵣ, μ_{g} | Rotor and gearbox dry friction (Nm) |
| G | Gear ratio |
| q_{g}, \dot{q}_{g} , \ddot{q}_{g} | Gearbox angular position (rad), velocity (rad/s), acceleration (rad/s²) |
| τ | Estimate torque vector |
| F | Estimate force vector |
| J^{T} | Arm/Leg Jacobian transpose |
| τₒ | Gearbox output torque vector |
| q, \dot{q}, \ddot{q} | Output angular position (rad), velocity (rad/s), acceleration (rad/s²) vector |
| M | Mass matrix |
| C | Coriolis matrix |
| bₘ | Damping vector |
| μₘ | Dry friction vector |

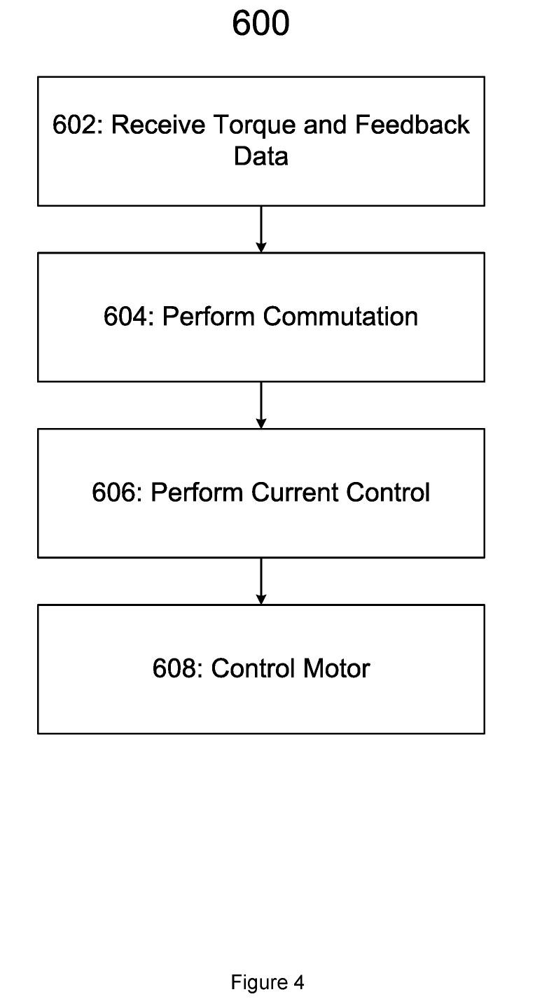

FIG. 4 is a motor control process 600 according to an embodiment of the invention. To perform motor control, in 602, control system 500 may receive data specifying desired torque, u, and, optionally, feedback from encoder 240. When encoder 240 data is present, in 604, sinusoidal commutation module 510 may perform commutation. In 606, voltage controller module 520 may use data specifying desired torque and/or output of sinusoidal commutation module 510 to generate a voltage space vector, and PWM module 530 may convert the voltage space vector to PWM duty cycles. In 608, PWM module 530 may feed PWM duty cycles to motor 200 to control motor 200 operation. While the input data specifies desired torque in this embodiment, other embodiments may specify desired force or a combination of desired forces and torques. For example, these control steps may proceed as follows in some embodiments.

Control system 500 may perform commutation. Unlike with brushed motors, as the rotor in a brushless motor spins, the control system 500 may adjust the winding currents in a frame moving with the rotor. This may rely on a position sensor attached to the rotor (e.g., hall sensor, encoder, or estimator from phase voltages). For low-speed applications such as servo control, for example, an encoder may be used. In sinusoidal commutation, commutation may be performed first and may be followed by tracking of the resulting sinusoidal current command signals. Reference signals may be time-varying (and hence affected by bandwidth phase lag in the current control process). Some embodiments may use sinusoidal commutation, as discussed in the examples herein, but other embodiments may use other techniques such as field oriented control or ideal commutation.

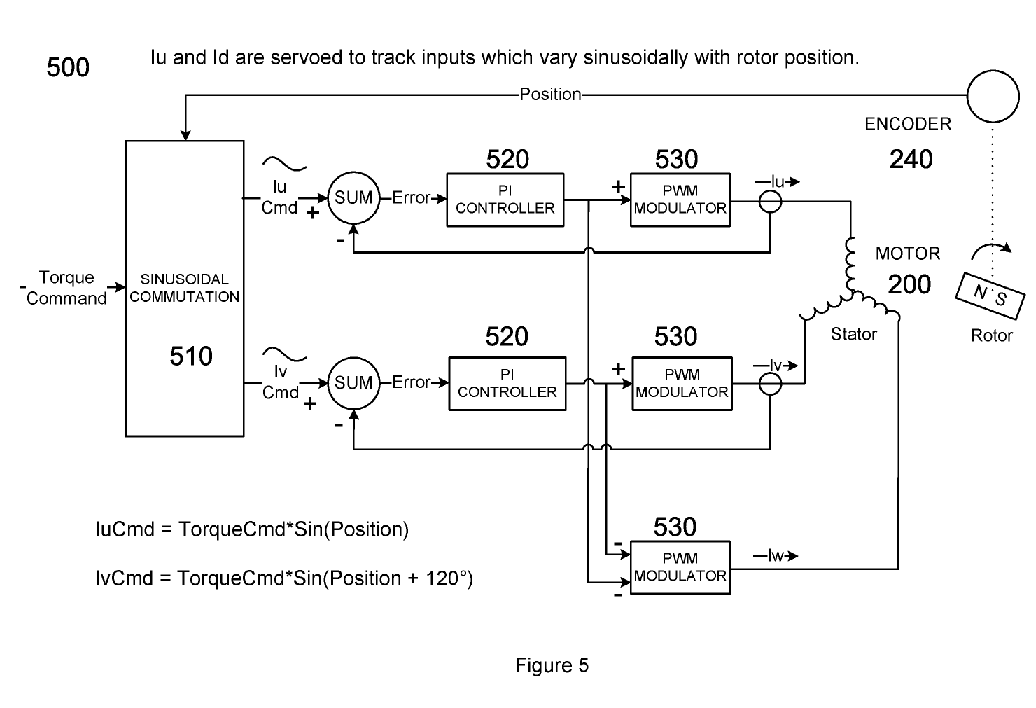

FIG. 5 is a block diagram of a control system 500 configured to perform sinusoidal commutation according to an embodiment of the invention. Sinusoidal commutation module 510 may derive a smoothly rotating current space vector in the motor coils whose magnetic field is exactly orthogonal to the rotor magnetic field.

Sinusoidally commutated brushless motor controllers 500 may attempt to drive the three motor windings with three currents that vary smoothly and sinusoidally as motor 200 turns. The relative phases of these currents may be chosen to provide a smoothly rotating current space vector that is substantially always in the quadrature direction with respect to the rotor and has substantially constant magnitude. These characteristics may reduce or substantially eliminate torque ripple and commutation spikes.

In order to generate smooth sinusoidal modulation of the motor currents as motor 200 turns, sinusoidal commutation module 510 may require an accurate measurement of rotor position. Accordingly, angle feedback may be provided by encoder 240 or a similar device.

Control system 500 of FIG. 5 may use a separate current loop for each of two motor winding currents. Since motor 200 is wye wired in this example, the current in the third motor winding may be equal to the negative sum of the currents in the first two windings according to Norton's current law, and therefore may not be separately controlled. Since the winding currents combine to produce a smoothly rotating current space vector of constant magnitude in this example, and because the stator windings are oriented 120 degrees apart from each other in this example, currents in each winding may be sinusoidal and phase shifted by 120 degrees.

Position information from encoder 240 may be used to synthesize two sinusoids, one 120 degrees phase shifted from the other. These signals may be multiplied by the torque command so that the amplitudes of the sinewaves are proportional to desired torque. Two sinusoidal current command signals appropriately phased to produce a rotating stator current space vector in the quadrature direction may result. The sinusoidal current command signals may be provided as inputs to a pair of controllers (e.g., voltage controller module 240) that may regulate current in the two motor windings. The current in the third motor winding may be the negative sum of the currents in the controlled windings and may not be separately controlled. The output from each voltage controller module 240 may be fed to PWM module 530 and then to the output bridge and two motor terminals. Voltage applied to the third motor terminal may be derived as the negative sum of the signals applied to the first two windings, as appropriate for three sinusoidal voltages each separated by 120 degrees. To the extent that the actual output current waveform accurately tracks the sinusoidal current command signals, the resulting current space vector may be smoothly rotating, constant in magnitude, and oriented in the quadrature direction.

The sinusoidal commutation implementation may rely on the following assumptions:
a) The rotor position is known perfectly (otherwise position estimator dynamics may be incorporated)
b) The winding voltage ν can be set arbitrarily (this is a standard assumption, and may depend on the PWM frequency and FET switching to occur at a much faster time scale than the motor electrical dynamics). For example, in direct-drive application with a T-motor U8 motor, the motor electrical time constant is

$${t}_{mot} = \frac{L}{R} = 698$$

μs. In some embodiments, the motor controller PWM switching frequency may be chosen to be 19 KHz, resulting in a switching time of t_{pwm}=52 μs, and the FET switching time may be ≈100 ns. We see that tₘₒₜ>>t_{pwm}, justifying this assumption. If motor 200 with smaller inductance is used, an inductor may be incorporated in series with motor 200.

With these assumptions, a standard lumped parameter model for an electric motor may be as follows. Sinusoidal commutation system may be a simple RL circuit with two voltage sources, the phase voltage and the back EMF caused by the permanent magnets in the stator. Phase currents may be output. Consequently, all other electromagnetic effects of the stator and permanent magnets may be ignored and may be considered in the next step of control. The back EMF voltage source may depend linearly on rotor speed \dot{q}ᵣ,

$$i = \frac{v - {k}_{e} {\dot{q}}_{r}}{R} - L \frac{di}{dt} \qquad \# ( 1 )$$

Note that there may be two distinct sources of

$$\frac{di}{dt} ,$$

one due to the rotation of the rotor, causing time-variation in the current reference (described above), which is referred to as

$$\frac{di}{dt} ( {\dot{q}}_{r} ) ,$$

and another as a result of changing current passing through the entire motor, which is referred to as

$$\frac{di}{dt} ( u ) .$$

See Rambabu, S. Modeling and control of a brushless DC motor. Diss. National Institute of Technology Rourkela, 2007, the entirety of which is incorporated by reference herein.

Control system 500 may perform current control. In order that a desired torque, u, be produced, control system 500 may adjust the voltage set to the windings (by adjusting the duty cycle of the PWM signal) in order to produce a desired current. The relation of the current induced to the voltage supplied may depend on the motor electrical parameters (resistance R, inductance L, back-EMF constant kₑ) and its electrical state (speed \dot{q}ᵣ, rate of current change

$$\frac{di}{dt} ) .$$

An example standard for motor electrical dynamics is described below.

Voltage controller module 520 may generate a voltage space vector corresponding to a desired current space vector as follows, for example. The standard model for the current control may use a PI controller to track the reference current signal. This may require at least two phase current sensors to be incorporated into the electrical design. These current sensors and their A/D converters may be expensive (in terms of cost), may require expensive processor time to sample in synchrony with the PWM signal, and may require either processor time or hardware filters to reject noise. A mathematical model for this is

v=k_{F}u+kₚe+kₗ∫e dt, # (2)

where

$$e := \frac{u}{{k}_{t}} - i$$

is the current tracking error, k_{F} is a constant feedforward coefficient which may be used in the embodiments described below, and kₚ, kₗ are PI gains that are used in standard implementation and tuned by hand.

Some embodiments may use the following approximate model for current control. In a high-transparency robotic manipulator, the following assumptions specific to the regime of operation may apply:
a) The speed of the motor, \dot{q}ᵣ, will be low relative to the motor's no-load speed because of the small gear ratio (described below). A low no-load speed of the output, after any gearing, may be less than 5 Hz. Alternatively, the no-load speed of a motor may be 27 Hz, while the robot leg in this example may never move faster than 5 Hz.
b) There will be rapid changes in desired torque or force, i.e. |\dot{u}|is high. For example, rapid changes in torque or force may entail changes from zero to peak torque or force of the actuator in <25 ms (i.e., 1400 Nm/s). In some embodiments, rapid changes may be from zero to peak torque or force in <20 ms.
c) A large-diameter motor (e.g., >80 mm for a small, 250 g motor) with high kₜ, L will be used (e.g., kₜ=0.095 Nm/A, L=130 uH). In some embodiments, high kₜ, L may result from characteristics such as kₜ>0.03 Nm/A and L>30 uH.

Given a) and b), the time-variation in the reference current signals due to motor rotation may be expected to be in the same order-of-magnitude as the time-variation in the desired input. This suggests that the benefits of FOC (minimizing the impact of

$$\frac{di}{dt} ( {\dot{q}}_{r} )$$

in current control) may be irrelevant in this regime. Consequently, FOC may be dropped in favor of sinusoidal commutation, which in return allows for a large reduction in computational complexity.

Second, in some embodiments,

$${k}_{F} = \frac{R}{{k}_{t}} , {k}_{P} = {k}_{I} = 0$$

in (2) above, resulting in the simple voltage controller

$$v = \frac{R}{{k}_{t}} u . \qquad \# ( 3 )$$

Note that this formulation may justify not using any current sensors,. This simplification may be justified since the closed-loop tracking error becomes (from (1) and (2)),

$$\dot{e} = - \frac{e}{{k}_{t} L} + \frac{1}{LR} {\dot{q}}_{r} + \frac{di}{dt} ( {\dot{q}}_{r} ) - \frac{1}{{k}_{t}} \dot{u}$$

Since kₑ=kₜ.

Given a) and c), the second and third summand on the right may be small. The first term may provide rapid stabilization of the error, and the last term may be a “disturbance” to this system that may not be modeled apriori (task-dependent). Minimizing this term may be difficult in any implementation, and thus the controller (3) may be adequate for near-perfect current tracking, i.e. e→0 and subsequently

$$i \to \frac{u}{{k}_{t}} .$$

Lastly, whereas PI controllers can be tricky to stabilize in the presence of rapidly changing reference signals (high |\dot{u}|), the previous approximation may minimize or eliminate this avenue of possible instability.

PWM module 530 may convert desired voltage space vector to PWM duty cycles. Details of space vector modulation for PWM can be found in: Ahmed, Waheed, and Syed M. Usman Ali. “Comparative study of SVPWM (space vector pulse width modulation) & SPWM (sinusoidal pulse width modulation) based three phase voltage source inverters for variable speed drive.”IOP Conference Series: Materials Science and Engineering. Vol. 51. No. 1. IOP Publishing, 2013, the entirety of which is incorporated by reference herein. While example embodiments herein use PWM to generate the control signals for motor 200, other embodiments may use other techniques such as analog control.

The above-described motor control may utilize a special operating regime (low-speed servo control) that allows for a good forward model of phase current i produced from input signal u, and the ability to take advantage of this model by reducing complexity of both the hardware and software components of this block as compared with traditional approaches, while still retaining good performance.

### Motor Construction

Specific details of motor construction may relate the current in the phases to the theoretical torque of the motor. The simplifications in the following description may provide that the motor torque may be assumed to be linearly related to motor current.

Starting with Faraday's law (induced voltage is linearly related to the velocity of the windings with respect to the permanent magnets) and Lorentz's law, (force is linear with the current in the windings) the standard model may consider the torque produced in a single lumped winding as τ=4Fr, where F is the force produced by a single winding pass. This force may be multiplied by two since the loop must go up the stator tooth, then back again, and multiplied by two again because there are two active phases in a 3-phase motor. The force may be broken down further as: F=mnlrBi according to the exact winding specifications of the winding and the strength of the permanent magnetic field, B. This magnetic field may be a function of the magnet grade (for typical Neodymium Iron Boron chemistry), temperature, permeability, and magnetic field strength, all of which may be shown in a B-H curve. All this complexity may be lumped into the magnet permeability, so B=p(c,H,T)H.

In this embodiment, the permanent magnets may be at a temperature and field strength corresponding with the linear portion of the BH curve, meaning B=pH. These embodiments may use magnets of grade N35SH, which has a maximum working temperature of 150° C. and a Curie temperature of 340° C., ensuring linear operation for a large fraction of the field strength range (e.g., in some examples, nonlinearity was only empirically noticeable starting at 2.5× continuous torque). This assumption may provide the following model:

τₘ=4mnlrBi=kₜi, so kₜ=4mnlrB.

Example standard models for rotational dynamics of the motor, gearbox dynamics, and arm/leg linkages may be as follows. These elements may be simplified as described with respect to the “full mechanical system and implementation justification” below.

The standard model for the rotational dynamics of the motor is τᵣ=τₘ−Jᵣ\ddot{q}ᵣ−bᵣ\dot{q}ᵣ−μᵣ(\dot{q}ᵣ), where the dynamics include the rotor inertia, viscous friction (assumed to be linear with velocity), and dry friction (either static or kinetic friction depending on motor velocity).

The gearbox dynamics may be a significant source of friction and may scale the motor dynamics, as seen at the output, τ_{g}.The standard model for the gearbox dynamics is τ_{g}=Gτᵣ−J_{g}\ddot{q}_{g}−b_{g}\dot{q}_{g}−μ_{g}(\dot{q}_{g}).

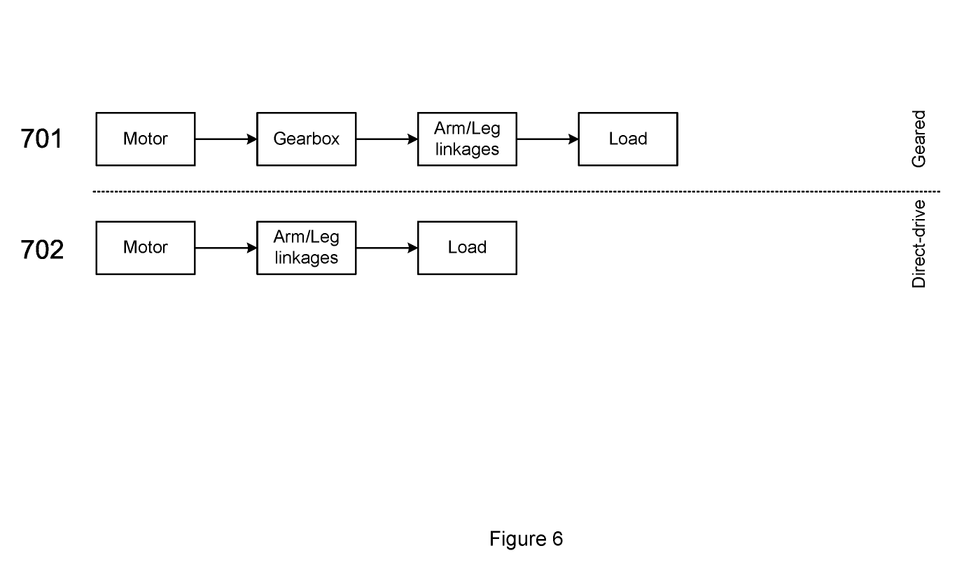

FIG. 6 is a comparison of manipulators 701, 702 according to an embodiment of the invention. In a robot system, mechanical compliance elements (e.g., series elastic elements) may be added between the gearbox and the linkage or after the linkage to protect the gears from impulses, or to decrease the impedance at the output. Embodiments described herein may not require the series elastic element and may either use a modest reduction gearbox (e.g., system 701), or none at all (e.g., system 702). Assuming a linear spring and damper, a standard model may be τₛ=k ₛ(q_{g}−q^{*})+k_{d}(\dot{q}_{g}−\dot{q}_{*}).

In cases where multiple actuators are used, they may be combined into an arm or leg using a linkage. The standard model for linkages may include rigid body dynamics and various frictions in matrix form, e.g., τ=J^{T}F=τ₀−M(q)\ddot{q} −C(q,\dot{q})\dot{q}+g(q)−bₘ\dot{q}−μ_{m(\dot{q}).}

### Full Mechanical System and Implementation Justification

The remaining discussion describes a full mechanical system and implementation justification according to an embodiment of the invention. Combining the motor mechanics, gearbox, series-elastic element, and arm/leg linkage dynamics may yield the following:

τ=J^{T}F=τₘ−(G³Mᵣ+M_{g}+M)\ddot{q}−(G²bᵣ+b_{g}+C+b)\dot{q}−(Gμᵣ+μ_{g}+μ)−kₛ(q−q*)−k_{d}(\dot{q}−\dot{q}*)+g

The encoders used for commutation may be differentiated numerically to obtain an estimate of velocity and acceleration. Consequently, given sufficient characterization of the dynamic properties, all the terms on the right side may be estimated. Embodiments described herein may minimize the inertia and frictions so that small errors in velocity and acceleration map to very small errors in torque. The strategy employed may minimize the actuator, transmission, and linkage dynamics.

To minimize gear ratio and actuator dynamics, a high-transparency actuator may either be direct-drive (no gearbox) or have a small gear reduction (e.g., less than 30:1). Since the gearbox is either small or non-existent, the following terms may also be small, with the first three being zero in the case of direct-drive: {G³Mᵣ, G²bᵣ, Gμᵣ, M_{g}, b_{g}, μ_{g}}. For example, the mechanical properties of an example implementation lacking a series elastic element (T-Motor U8, DD, no series elastic element (SEA)) may give the results in Table 2.

TABLE 2

| | |
|---|---|
| Reflected inertia: G³Mᵣ + M_{g} (kg m²) | 0.0001 |
| Static friction: Gμᵣ + μ_{g} if \dot{q} = 0 (Nm) | 0.056 |
| Kinetic friction: Gμᵣ + μ_{g} if \dot{q} > 0 (Nm) | 0.023 |
| Viscous friction: G²bᵣ + b_{g} (Nm/rad/s) | 0.00013 |
| SEA stiffness: Kₛ (N/m) | none |

it is clear that the above terms in the direct drive implementation may be small enough to be neglected. Moreover, the accelerations and velocities of the motor may be small (linear in G) with the joint velocity/acceleration (which may be small by motor standards), and the product may be small, and hence the magnitude of the estimator error may be small. This high-transparency actuator may be accomplished by the following design strategies, which may serve to decrease the necessary mechanical reduction (gear ratio, etc.) for a given torque or force requirement:

1) To improve mass-specific torque, brushless outrunner (rotor on the outside) motors with a large gap radius and minimal thickness may be used. For example, the ratio of gap radius to thickness may be 1 or more (e.g., an example embodiment may have a gap radius of 43 mm and thickness of 26 mm for a small 250 g motor). The larger the mass-specific torque of the motor, the smaller the necessary gear ratio for a given torque requirement.

2) By monitoring the temperature of the motor windings, the torque may be safely brought above its thermally continuously sustainable limit. Because it may be difficult to instrument the motor windings directly, a thermal observer may be used to estimate winding temperature.

3) As large as possible mass fraction of the machine may be devoted to the actuators to improve the full system's mass-specific torque.

4) An actuator may be selected with good thermal specific torque (Nm/(kg °C.^{0.5})), for example a thermal specific torque to gap radius (in meters) greater than 4 (Nm/(kg °C.^{0.5}))/m. A further advantage, alongside the desirable geometric traits for a motor, may be that lightweight construction can be prioritized by using lower density structural materials such as aluminum or composites for the rotor and most of the stator (the exception may be inside the windings, where high flux density may be preferable). An open-back design may be employed, as it may be attached to a frame or heatsink for improved heat dissipation, in addition to the active convection provided by the spinning rotor. Good winding wire packing density and many pole pairs may be desirable.

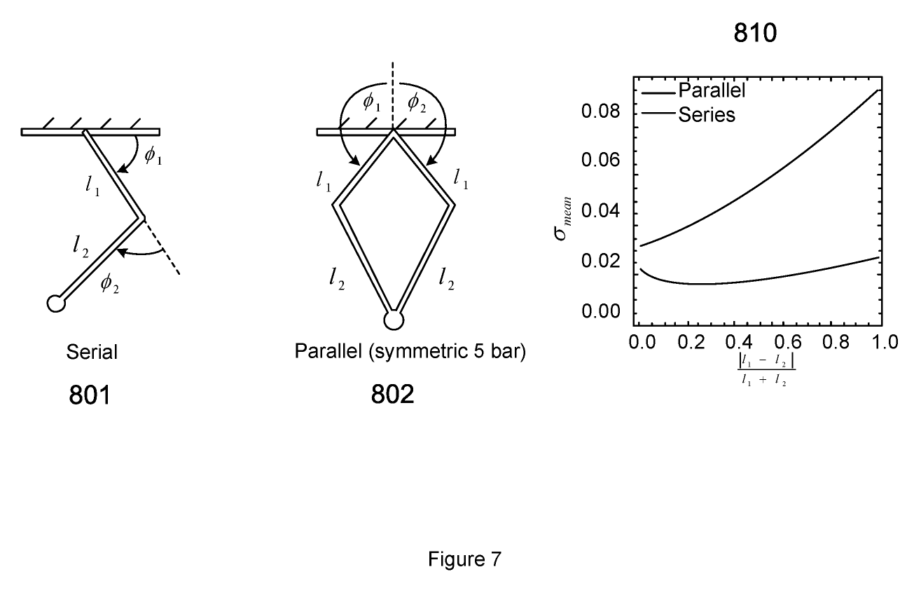

5) FIG. 7 is a comparison of serial 801 and parallel 802 linkages according to an embodiment of the invention. When actuators are combined into linkages, they may be in parallel 802 (as opposed to series 801) wherever possible. This may improve the thermal cost of force production (the mean of the linkage Jacobian's singular values, σₘₑₐₙ) as shown in graph 810 of FIG. 7. The example parallel linkage 802 (a symmetric five bar) outperforms the series linkage 801 for all choice of link ratios

$$\vert \frac{{l}_{1} - {l}_{2}}{{l}_{1} + {l}_{2}} \vert$$

by up to a factor of 4.

6) When a linkage with multiple degrees of freedom is used, actuated degrees of freedom (n) may be minimized, as mass-specific torque decreases ∝n⁻¹ in parallel and ∝n⁻² in series.

7) For a parallel linkage such as the symmetric five bar 802 shown in FIG. 7, the full range ({ϕ₁, ϕ₂} ∈ [0, π] may be used. In addition to the workspace advantage, there may be dynamic benefits due to the changing effective mechanical advantage compared to designs that restrict {ϕ₁, ϕ₂} ∈ [π/2, π] resulting in a 2.1× increase in energetic output from a fixed power source.

A light linkage with low-friction joints may be used to minimize {M, C, b, μ, g}. This may be aided by using as few active degrees of freedom as possible (for example 2/leg instead of 3+), and/or by using tubular or composite structures.

### Additional Features

As discussed above, the disclosed systems and methods may perform feed-forward motor control based only on a desired force (or torque) input to drive motor output force (or torque) to be substantially the same as the desired force (or torque). Some embodiments may use position information to perform commutation. Some embodiments may further use the position information to include the following additional features. Note that current feedback, torque feedback, and/or force feedback are not required for the additional features.

Desired impedance may be achieved through virtual compliance (having the motors mimic arbitrary spring-damper systems) instead of by using mechanical springs and dampers. This strategy may be possible if the reflected inertia of the motor and transmission is small, achieved by the above strategies, thereby eliminating the following terms completely: {kₛ, k_{d}}.

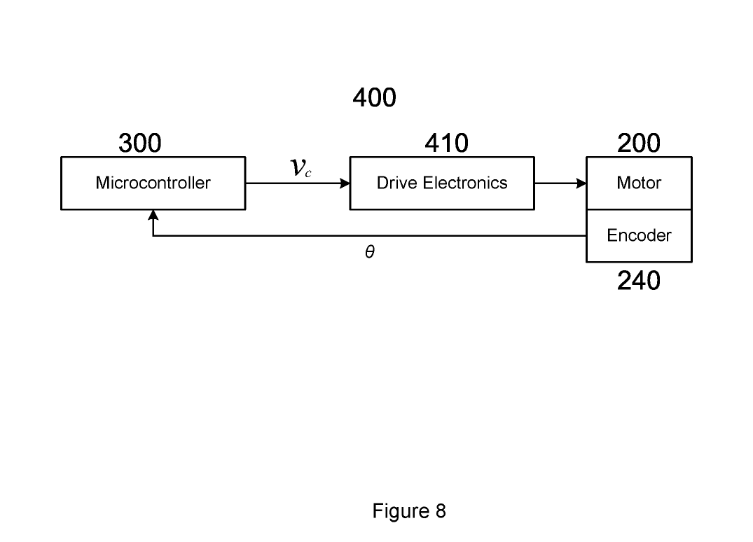

FIG. 8 is a block diagram of an electrical system 400 according to an embodiment of the invention. As discussed above, microcontroller 300 may use position information from the motor's encoder 240, θ, both to calculate the desired voltage, V_{c}, (a function of angular position and velocity), as described in the block diagram, and to perform commutation if necessary. System 400 may use θ to calculate V_{c}, for example, to enhance motor control by adding a force estimation to V_{c} based on position data reported by encoder 240. Accordingly, system 400 may add spring emulation to the control signal V_{c}, as illustrated in the block diagram. The resulting signal may be amplified by drive electronics 410. The amplified output of drive electronics 410 may induce a current in the phases of motor 200.

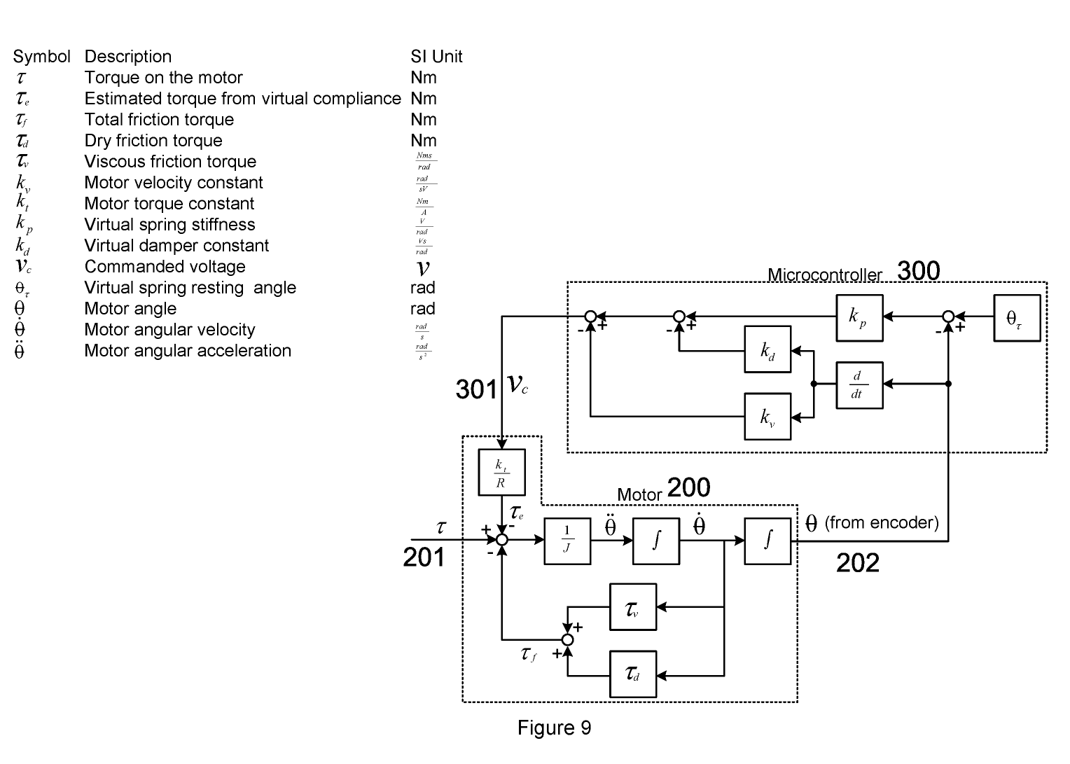

FIG. 9 is a block diagram of a motor 200 and a microcontroller 300 according to an embodiment of the invention. In this block diagram, the input 201 is the external torque, τ, (the signal of interest to be estimated) which goes through the motor dynamics resulting in a position 202, θ, which may be measured by an encoder. As shown, motor 200 characteristics (e.g., motor torque constant kₜ and total friction torque τ_{f} (itself a function of dry friction torque τ_{d} and viscous friction torque τᵥ) affect the resulting position 202.

Microcontroller 300 may compute a voltage signal 301 that may be sent back to the motor, V_{c}, depending on the specifics of the active compliance law (kₚ, k_{d}, θᵣ). Voltage signal 301 may be the voltage control signal that is converted into a control signal for motor 200 by PWM module 530 (i.e., the output of voltage controller 520), for example. The external torque, τ, acting on the motor shaft may be decomposed into lost torque information, for example due to friction, τ_{f}, and the estimated torque, τₑ, based on readings from the position sensor and programmed active compliance parameters.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method of controlling a motor, the method comprising:
receiving, at a voltage control module, command data indicating only a desired torque and/or force for the motor and including no torque and/or force or current feedback data from the motor;
based on the command data and at least one motor characteristic and no separate torque and/or force or current feedback data, generating, by the voltage control module, a voltage signal corresponding to a desired motor current to produce the desired torque and/or force ;
generating, by a modulation module in communication with the voltage control module, a control signal configured to provide the motor with the desired motor current using only the voltage signal as an input; and
controlling the motor by inputting the control signal to the motor, wherein the inputting causes the motor to output substantially the desired torque and/or force .

2. The method of claim 1, further comprising performing commutation using the command data to produce commutated command data, wherein the voltage signal generated by the voltage control module is based on the commutated command data and no separate feedback data.

3. The method of claim 2, wherein performing commutation comprises:
receiving, at a sinusoidal commutation module in communication with the voltage control module, the command data; and
generating, by the sinusoidal commutation module, the commutated command data by performing sinusoidal commutation for the motor using only the command data and motor position data as inputs.

4. The method of claim 3, further comprising generating, by an encoder coupled to the motor, the motor position data.

5. The method of claim 1, wherein generating the control signal comprises performing pulse width modulation on the voltage signal.

6. The method of claim 1, wherein an output torque and/or force of the motor matches the desired torque and/or force within 5-20% error for stationary applications and/or within 10-30% error throughout a velocity/acceleration range for the motor.

7. The method of claim 1, wherein the motor is configured for direct drive or to drive a gearbox with a gear reduction of less than 30:1.

8. The method of claim 7, wherein the motor is configured to drive a load directly or through the gearbox at a speed less than 5 Hz.

9. The method of claim 1, wherein the desired torque and/or force received in the command data by the voltage control module varies from zero to peak torque and/or force in less than 20 ms.

10. The method of claim 1, wherein the motor is a brushless motor with a radius to thickness ratio greater than 1.

11. The method of claim 1, further comprising driving, by the motor, an actuator.

12. The method of claim 11, wherein the actuator comprises a parallel linkage.

13. The method of claim 11, wherein the actuator has a thermal specific torque to motor gap radius ratio greater than 4 (Nm/(kg °C.^{0.5}))/m.

14. The method of claim 1, wherein at least one of reflected inertia, static friction, kinetic friction, viscous friction, actuator speed-torque curve, and series elastic element stiffness are ignored by the voltage control module and the modulation module.

15. The method of claim 1, further comprising adding, with the voltage control module, compliance emulation based on motor position data to the voltage signal before the modulation module uses the voltage signal to generate the control signal

16. A system configured to control a motor, the system comprising:
a voltage control module configured to:
receive command data indicating only a desired torque and/or force for the motor and including no torque and/or force or current feedback data from the motor; and
based on the command data and at least one motor characteristic and no separate torque and/or force or current feedback data, generate a voltage signal corresponding to a desired motor current to produce the desired torque and/or force ; and
a modulation module in communication with the voltage control module configured to generate a control signal configured to provide the motor with the desired motor current using only the voltage signal as an input;
wherein the system is configured to control the motor by inputting the control signal to the motor, wherein the inputting causes the motor to output substantially the desired torque and/or force .

17. The system of claim 16, wherein:
the system is further configured to perform commutation using the command data to produce commutated command data; and
wherein the voltage signal generated by the voltage control module is based on the commutated command data and no separate feedback data.

18. The system of claim 17, further comprising a sinusoidal commutation module in communication with the voltage control module and configured to:
receive the command data; and
generate the commutated command data by performing sinusoidal commutation for the motor using only the command data and motor position data as inputs.

19. The system of claim 18, further comprising an encoder coupled to the motor and configured to generate the motor position data.

20. The system of claim 16, wherein the modulation module is configured to generate the control signal by a process comprising performing pulse width modulation on the voltage signal.

21. The system of claim 16, wherein an output torque and/or force of the motor matches the desired torque and/or force within 5-20% error for stationary applications and/or within 10-30% error throughout a velocity/acceleration range for the motor.

22. The system of claim 16, wherein the motor is configured for direct drive or to drive a gearbox with a gear reduction of less than 30:1.

23. The system of claim 22, wherein the motor is configured to drive a load directly or through the gearbox at a speed less than 5 Hz.

24. The system of claim 16, wherein the desired torque and/or force received in the command data by the voltage control module varies from zero to peak torque and/or force in less than 20 ms.

25. The system of claim 16, wherein the motor is a brushless motor with a radius to thickness ratio greater than 1.

26. The system of claim 16, wherein the motor is configured to drive an actuator.

27. The system of claim 26, wherein the actuator comprises a parallel linkage.

28. The system of claim 26, wherein the actuator has a thermal specific torque to motor gap radius ratio greater than 4 (Nm/(kg °C.^{0.5}))/m.

29. The system of claim 16, wherein at least one of reflected inertia, static friction, kinetic friction, viscous friction, actuator speed-torque curve, and series elastic element stiffness are ignored by the voltage control module and the modulation module.

30. The system of claim 16, wherein the voltage control module is further configured to add compliance emulation based on motor position data to the voltage signal before the modulation module uses the voltage signal to generate the control signal
